(19) United States
(12) Patent Application Publication
(10) Pub. No.: US 2021/0024248 A1
(43) Pub. Date: Jan. 28, 2021

(54) FITMENTS

(71) Applicant: Concept Packaging Services Limited, Shipley (GB)

(72) Inventor: Christopher Paul HALLAM, Shipley (GB)

(21) Appl. No.: 16/947,250

(22) Filed: Jul. 24, 2020

(30) Foreign Application Priority Data
Jul. 24, 2019 (GB) 1910602.0

(51) Int. Cl. B65D 5/50; B65D 81/133

(52) U.S. Cl. CPC B65D 5/5057; B65D 2581/053; B65D 81/133

(57) ABSTRACT

A fitment including a first layer and a second layer suitable for securing to each other via a mechanical engagement feature, wherein the mechanical engagement feature aligns the first layer and the second layer relative to each other when the layers are engaged and the fitment is folded such that the layers are in contact and at least one of the layers at least partially encloses the other layer.

### RELATED APPLICATION

The present application claims priority to GB Application No. 1910602.0 filed Jul. 24, 2019, which is hereby incorporated herein in its entirety by reference

### TECHNICAL FIELD

The present disclosure relates to packaging cartons, the blanks suitable for construction of such cartons and methods of manufacturing such cartons. More specifically, the present disclosure relates to cartons which provide a fitment which may be made from, for example, cardboard.

### BACKGROUND

Cartons are a well-known and desirable way of packaging goods, being suitable for use with a variety of different goods by forming the carton from a material of suitable strength and quality. However, cartons are typically less suitable for transporting fragile consumer goods, particularly those with non-uniform shapes such as cosmetic bottles and tubes and liquor. This is because the carton cannot typically be formed to the same shape as the object to provide support.

For such consumer products cartons are typically used only in a decorative fashion. Typically a product is packaged inside a form fitting plastic, so as to be robustly contained, and then the plastic container is itself enclosed in a thin cardboard carton. This is because a cardboard carton is easier and cheaper to print branding and advertising onto compared to the plastic surface of the container.

Recently however there has been a marked negative shift in public attitudes towards plastic products, and in particular plastic packaging which is difficult if not impossible to recycle. Consumers are looking for their products to be supplied in an environmentally friendly way and thus there is a need to provide alternative product packaging.

### SUMMARY

The present disclosure is concerned with alternative product packaging techniques that do not rely on plastic.

According to the present disclosure in a first aspect, there is provided a fitment comprising a first layer and second layer suitable for securing to each other via a mechanical engagement feature, wherein the mechanical engagement feature aligns the first layer and second layer relative to each other when the layers are engaged and the fitment is folded such that the layers are in contact and at least one of the layers at least partially encloses the other layer.

Suitably, the first layer comprises a tab and the second layer comprises an opening, the tab and opening together forming the engagement feature and being engaged when the tab is inserted into the opening.

Suitably, the tab is larger than the opening in at least one dimension.

Suitably, the tab is provided with at least one flange to extend the tab in the at least one dimension.

Suitably, the engagement feature is positioned on a side wall of the fitment.

Suitably, the fitment comprises at least two engagement features.

Suitably, the engagement features are positioned symmetrically opposite each other on opposite sides of the fitment with respect to a center line of the fitment.

Suitably, the first layer and second layer are substantially the same shape and are folded along substantially the same lines when in use and the layers are considered to be aligned when the fold lines of the first layer are coincident with the fold lines of the second layer.

Suitably, the engagement feature comprises a neck portion along which the first layer is moved relative to the second layer to adjust the position and alignment of the two layers after engagement.

Suitably, the next portion provides for a side wall angle of 45 degrees relative to a surface of the fitment when the fitment is folded in use.

Suitably, the first layer and second layer are different thicknesses.

According to the present disclosure in a second aspect, there is provided a carton in combination with a fitment according to the first aspect of the disclosure.

Suitably, the engagement feature of the fitment is obscured from view of a user of the carton during normal use.

According to the present disclosure in a third aspect, there is provided a fitment comprising a first layer and a second layer, the first layer comprising a first foldable window and the second layer comprising a second foldable window, wherein the first foldable window is substantially aligned with the second foldable window, and wherein the second window provides a supporting force to the first window during a folding action of folding the first window towards the second window.

Suitably, the first window and second window are formed from at least one foldable flap on the respective layer.

Suitably, the first window comprises a crease line which is substantially coincident with a crease line of the second window, and wherein the folding action causes the two layers to fold along the same line.

Suitably, the crease line of the first window is provided as a lightweight indent whilst the crease line on the second window is provided as a stronger indent or score compared to the first window.

Suitably, a force required to fold the first window is greater than a force required to fold the second window and less than a force required to fold an un-creased part of the second layer.

Suitably, the first layer comprises one or more of cartonboard or microflute, and the second layer comprises one or more of sold board or corrugated cardboard.

Suitably, both the first layer and second layer comprise microflute corrugated cardboard.

According to the present disclosure in a fourth aspect, there is provided a method of manufacturing a fitment according to any one of the claims alone or in combination, comprising overlapping the first layer and second layer such that the engagement feature is in a position ready for engagement, and mechanically manipulating the first layer and second layer such that the engagement feature engages whilst simultaneously folding the first and second layer alone at least one predetermined fold line.

Suitably, the method further comprise manipulating the folded and engaged first and second layers into a substantially two-dimensional configuration such that the fitment exists in a pre-folded state.

Suitably, the pre-folded fitment is provided to a user ready for manipulation into a three-dimensional configuration.

According to the present disclosure in a fifth aspect, there is provided a method of pre-folding a fitment comprising a layer with at least one predetermined fold line, the method comprising: providing the fitment to a mechanical folding device in a substantially flat configuration, mechanically manipulating the fitment so that the fitment is folded along the at least one-pre-determined fold line, and returning the fitment to the substantially flat configuration.

### BRIEF DESCRIPTION OF FIGURES

For a full understanding of the present disclosure reference will now be made to the accompanying drawings, in which:

FIG. 1 shows an example of a fitment in use.

FIG. 2 shows a perspective view of an example fitment.

FIG. 3A shows a plan view of a first layer of an example fitment.

FIG. 3B shows a plan view of a second layer of an example fitment.

### DETAILED DESCRIPTION

One alternative to the use of plastic containers for is to package products using a cardboard fitment. A fitment is provided with holes, or similar structures, on a major surface to receive a product, and is designed to be inserted into a larger container. Where multiple products are to be packaged in a single container it is common for a fitment to separate one product from another.

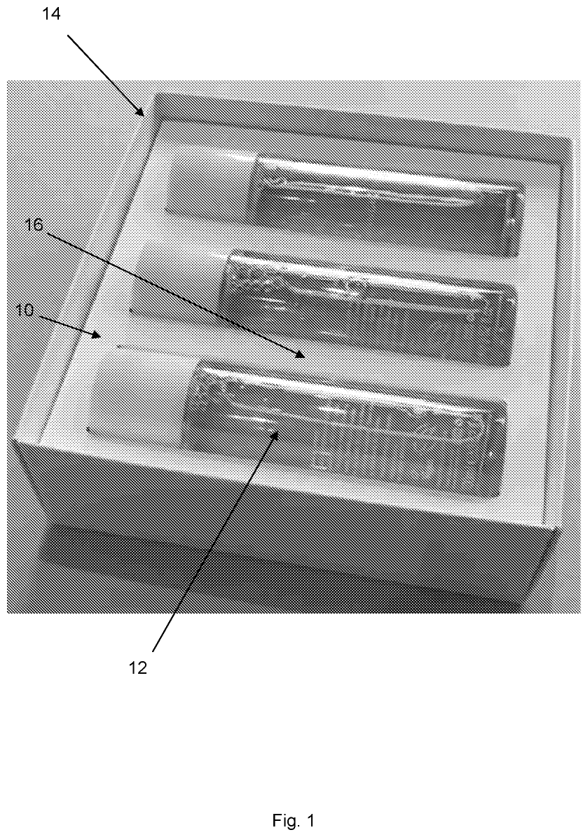

FIG. 1 shows an example of a fitment 10 used in the manner just described. Here the fitment 10 receives one or more products 12 whilst positioned inside a packaging container 14. In this example the fitment 10 is shown matching the form factor of the container 14. Of course the fitment 10 could more generally be any shape suitable for insertion into the container 14.

In order to provide visibly appealing fitments it is desirable to construct the fitment out of a material which is easy to print onto. In this way a major surface 16 which is visible when the product is open on a shelf or opened by a consumer may be made aesthetically appealing by virtue of e.g. the quality of the card, images printed onto the card, or a combination thereof. Printing capability and capacity is readily available for cardboard below a thickness of around 700 microns, and sometimes as thick as 800 microns. The quality and range of print finishes tends to be greater at lower calipers. Beneficially, the thinner the cardboard the less obvious, and therefore more aesthetically pleasing, the fold lines necessary for constructing a fitment may be. Suitably an aesthetically pleasing crease is usually sufficient to guide the folding of thin and/or high quality card. A disadvantage however is that small thickness fitments are not robust or sturdy and so prone to damage, either during transportation or more often during construction and manipulation of the fitment into shape/position. Therefore whilst the initial cardboard and print cost is low, there is a high associated cost in terms of wastage. This is problematic for the manufacturer and the environment.

Printing beyond the 800 micron threshold is possible but less readily available in terms of facilities readily set-up to perform printing at greater thicknesses. Typically specialist, and expensive, print methods have to be employed in order to print directly onto these thicker cardboard materials. In addition, thicker materials require more defined and obvious fold lines, often requiring a score or cut into the card, which results in a cruder appearance. Thicker materials therefore tend to be unsuitable for so called “high end” packaging purposes, and inappropriate for use as a fitment when where the fitment will be visible, such as display items on a shop shelf.

An advantage of thicker materials is firmer securing of a product 12 in the fitment due to the robustness of the material. Therefore the products 12 are stored safer and less prone to damage. Fitments made from thicker materials also have the advantage of being less prone to damage during construction and manipulation of the fitment due to the better defined and easier to fold along fold lines

It is therefore desirable to provide a fitment which enjoys the structural benefits and thicker materials with the aesthetic benefits of thinner materials.

The solution of the present disclosure to this materials problem is to construct the fitment from a combination of two layers of cardboard. That is, the fitment 10 is formed from a decorative first layer and a robust second layer. In the example of FIG. 1 the major surface 16 is oriented to face vertically out of the container 14, therefore the decorative first layer may be regarded as a top layer whilst the robust second layer may be regarded as an under layer. Put another way the first layer may be regarded as an outer layer which encloses the second inner layer. In this way, products 12 may be packaged securely and controllably using the fitment 10 whilst maintaining aesthetic quality.

### Attaching the Fitment Layers

The problem now arises of how to attach the decorative (first) layer and robust (second) under layer of the fitment 10. One solution is of course to use glue in order to adhere the layers together. Glue is advantageous for providing strength when bonding the layers together, and therefore glue increases the longevity of the fitment 10. One problem however is that the two layers must be perfectly aligned during manufacture: once the glue has bonded the layers they cannot be re-aligned. Typical manufacturing processes which bond cardboard layers have a tolerance of +/−2 mm and so it is common for the layers to be misaligned. Misalignment can result in the fitment being unable to be folded into shape or inserted into the package, leading to wastage, as well as resulting in a poor aesthetic finish thereby making the product appear poor quality. Another problem with many industrial glues is that they are neither sustainably produced nor recyclable. Thus, while a consumer believes that they are purchasing a product which has been responsibly packaged due to the use of cardboard, they will in fact be unable to recycle the packaging due to the use of the glue. Thus this potentially recyclable fitment will instead end up in landfill.

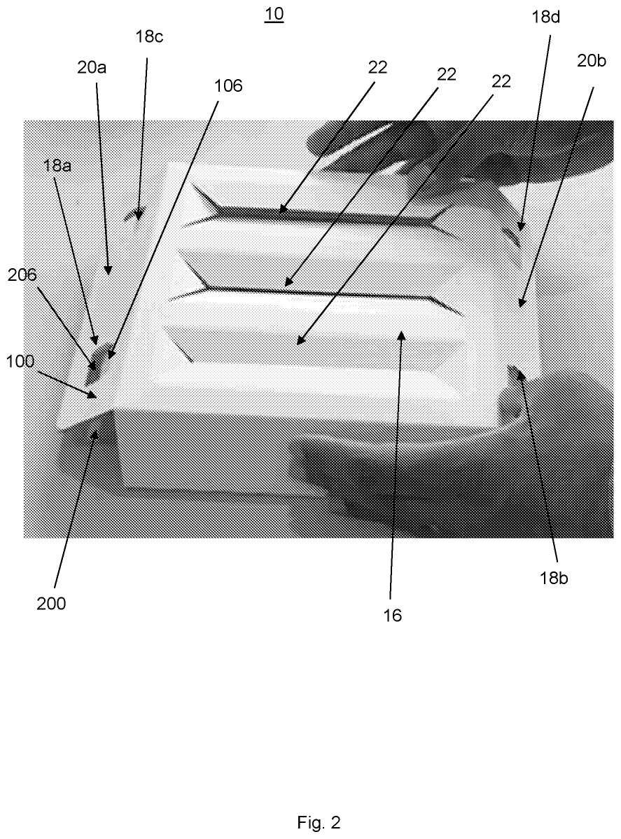

FIG. 2 shows an example layered fitment 10 comprising a first layer 100 and second layer 200 whereby the layers have been attached without the use of glue. As discussed above, the first layer 100 may be regarded as a top decorative layer and the second layer 200 as a robust under layer which is thicker than the first layer. In particular, the first layer may be ≤0.7 mm while the second layer may be >0.7 mm. In this example the fitment 10 has been partially folded into the three dimensional cube like shape suitable for insertion into the container 14 shown in FIG. 1.

The fitment 10 comprises an engagement feature 18 which securely engages the first layer 100 with the second layer 200. That is, the first layer and second layer are secured, or locked, together in alignment through the use of the engagement feature 18.

The engagement feature 18 comprises a tab 106 attached to the first layer 100 which is inserted into an opening 206 located in the second layer 200. Suitably the tab 106 is oversized compared to the opening 206 such that the tab 106 cannot be easily removed from the opening 206. That is, the tab 106 may be made larger than the opening 206 in at least one dimension such that the tab 106 overlaps the opening 206 when engaged. In this way inserting the tab 106 through the opening 206 draws first and second layer together and mechanically secures the layers relative to each other. Thus the first layer 100 and second layer 200 may be attached to each other without the use of glue or other adhesive agent. Suitably the component parts of the engagement feature 18 may be reversed so as to be on the alternative layer. That is, in an alternative example arrangement (not shown), the tab 106 may be provided on the second layer 200 and the hole 206 on the first layer 100.

In some embodiments the engagement feature 18 is positioned on a side wall 20a of the fitment 10, as in the example shown. Advantageously the engagement feature 18 is positioned away from other moveable parts of the fitment 10, such as the product receptors 22, and also in a position where the engagement feature will not be visible when the fitment 10 is inserted into container 14. In other words, it can be advantageous that the engagement feature 18 is not provided on the major surface 16. If the engagement feature 18 is provided on the major surface 16 then an additional securing means is suitably required on the side walls 20a, 20b, etc., in order to ensure that the first layer 100 does not fold back away from the second layer 200. Suitably however the engagement feature may be positioned anywhere that the two layers 100 and 200 overlap.

The fitment 10 may be provided with a plurality of engagement features 18 in order to provide stronger attachment of the two layers 100, 200. In the example shown two engagement features are provided on the side wall 20a and two are provided on the side wall 20b.

Although any number of engagement features may be provided it can be advantageous that at least two are provided on opposite sides of the fitment 10 in order to form an engagement pair, and that further engagement features are also provided in pairs. That is in the example shown the engagement feature 18a on side wall 20a forms one half of a pair with engagement feature 18b on the side wall 20b. It also can be advantageous that a pair of engagement features is symmetrically positioned on the layers 100, 200; in other words engagement features 18a and 18b can be equidistant from a center of mass of the fitment 10.

Providing two engagement features 18a, 18b on opposite sides 20a, 20b of the fitment 10 allows for the layers 100, 200 of the fitment 10 to automatically align when the layers are engaged. For example, assuming that the engagement feature 18a of side wall 20a has been engaged, then subsequently engaging engagement feature 18b of side wall 20b will ensure that the two layers are in contact along side walls 20a, 20b and major surface 16. The two layers 100, 200 will be pulled into alignment along the axis joining engagement features 18a and 18b. Further providing at least one more pair of engagement features 18c and 18d along the side walls 20a and 20b, parallel to the first pair 18a, 18b but separate from them, allows for automatic alignment along the orthogonal axis 18a-18c/18b-18d. Advantageously any misalignment of the layers 100, 200 arising during the construction of the fitment 10 is corrected for.

In addition, the engagement features 18a, 18b can be suitably designed to allow or restrict movement in certain directions, e.g. along their hypothetical axis. In this way oppositely aligned engagement features 18a, 18b may be used to define the shape of the final fitment. For example, the engagement features 18a, 18b may be constructed to only allow the side walls 20a, 20b to be folded to a 45-degree angle relative to the major surface 16, thereby creating a trapezoid shaped fitment rather than a cuboid as in FIG. 1. Of course any suitable angle between 0 and 180 degrees could be constructed.

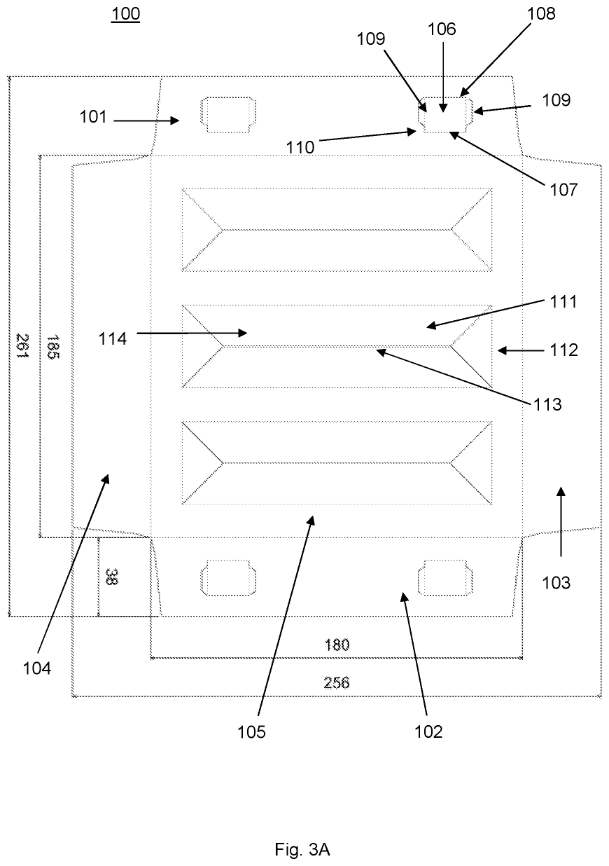

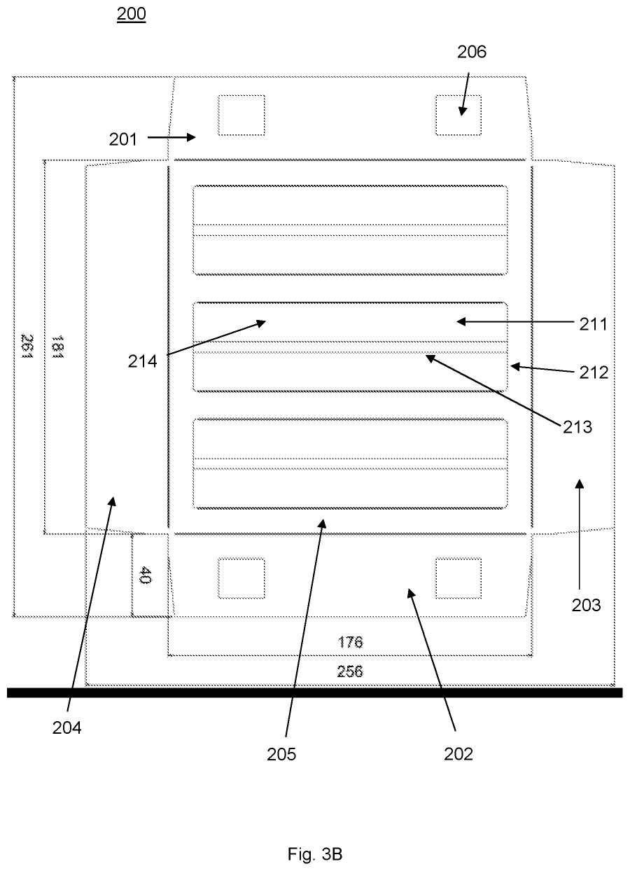

FIGS. 3A and 3B show the first layer 100 and second layer 200 in plan view, unfolded and unengaged with each other. The first layer 100 comprises first, second, third, and fourth side walls 101, 102, 103, and 104 respectively, each connected to a common wall 105. The common wall 105 is the same as the major surface 16 shown in FIGS. 1 & 2. The second layer 200 also comprises first, second, third, and fourth side walls 201, 202, 203, and 204 respectively, each connected to a common wall 205. The first layer 100 and second layer 200 are arranged to be substantially the same shape such that they have substantially the same outline and dimensions. That is, when the first layer 100 is overlaid flat on top of the second layer 200 the boundaries of each layer 100, 200 substantially match. When the layers are engaged the walls 101-105 of the first layer will be in contact with the respective walls 201-205 of the second layer.

The tab 106 is formed as part of the first side wall 101 of the first layer 100. The tab 106 is foldably attached to the first layer 100 by a hinged connection along the line 107. In the example shown the tab is formed by cutting the remaining edges 108 of the tab such that the tab is an integral part of the first layer 100. The tab 106 may be provided with flanges 109 which extend the tab 106 in one or more dimensions. The flanges 109 may be hingedly connected to the tab 106 in order to allow for flexibility. The tab 106 may also be provided with a neck 110 which extends between the hinged connection 107 towards the flanges 109, as shown.

The opening 206 is formed as part of the first side wall 201 of the second layer 200. The opening may be formed as a cut out from the second layer 200. The opening 206 may be formed such that it is entirely enclosed by the second layer 200 (side wall 201 in this example), i.e. the opening 206 is a hole, or may be formed such that the opening is partly along an edge of the layer 200, i.e. the opening 206 provides a castellation effect. The opening 206 may be any shape but in various embodiments is shaped to match, or at least accommodate, the tab 106.

The tab 106 and opening 206 are positioned on their respective layers such that they overlap each other when the layers overlap. In other words, the tab 106 is directly above the opening 206 when the first layer 100 is positioned on top of the second layer 200 such that their shapes are aligned. When the two layers 100, 200 are overlaid, the first layer 100 and second layer 200 may be engaged with each other by inserting the tab 106 into the opening 206; i.e. the tab 106 folds along the hinge 107 so that it can be folded towards and through the opening 206. In this way the decorative first layer 100 may be mechanically engaged with the sturdy and robust second layer 200.

The flanges 109 facilitate engagement of the tab 106 with the opening 206 by ensuring that the tab 106 is oversized compared to the opening 206. That is, when the tab 106 is inserted through the opening 206 such that the bottom side of the first layer 100 and top side of the second layer 200 are in contact, the flanges 109 maintain contact with the bottom side of the second layer 200. In this way oversizing the tab 106 provides mechanical engagement of the first layer 100 with the second layer 200.

Suitably the neck 110 allows for adjustment and alignment of the first layer 100 with respect to the second layer 200 after engagement of the two layers. The two layers 100, 200 may be generally regarded as in alignment when the fold lines of the first layer are coincident with the fold lines of the second layer; e.g. the fold lines defining the first layer side walls 101-104 are coincident with the fold lines defining the second layer side walls 201-204.

The degree of movement, and therefore adjustment, available is determined by the length of the neck portion 110; i.e. the separation between the hinge 107 and flanges 109 which defines the neck portion 109. Such re-alignment of the layers after engagement would not be possible with other connection means such as glue. The neck portion 110 also advantageously controls the final shape of the fitment 10 by defining the degree of relative movement available to the layers 100, 200 when engaged and manipulated into the three dimensional fitment shown in FIGS. 1 & 2.

The engagement mechanism described herein thus allows for the fitment 10 to be easily manufactured as two separate layers while avoiding costly and un-environmentally friendly manufacturing techniques. Fitments constructed using these methods are less prone to failure because the alignment is guaranteed as the two layers move naturally into position relative to each other.

### Manufacturing the Fitment

Presently a fitment is produced as a single layer of cardboard which is supplied to a customer. A customer in this sense is a person or company that intends to use the fitment when packaging their goods for supply to consumers. Due to the demands of efficient supply it is typically not suitable to arrange the fitment in three-dimensional (3D) shape prior to shipping. Rather, the fitment is supplied unfolded in the original flat configuration and must be arranged for use by a (human) packager. As part of forming the 3D fitment the packager must manipulate and fold the fitment by hand which is, of course, time consuming. The packager might require specific training in order to understand how to fold the fitment—e.g. in order to fold along the correct crease lines—and is also at risk of causing damage to the fitment during the folding process leading to wastage.

Problems associated with hand forming the fitment would only be exacerbated by the two layer fitment proposed above. This is because packaging factories are set up to print and prepare—e.g. with crease lines—a single cardboard layer at a time. Thus, in order to supply packaging users with the fitment 10, the two layers 100, 200 would necessarily be manufactured separately and provided to packagers separately. The two separate layers 100, 200 would then be engaged with each other at the packaging site prior to being folded into a single three-dimensional fitment ready for products. Forming the fitment in this way would require extra care and attention in order to ensure accurate alignment of the two layers 100, 200. Clearly it is inefficient from a both a logistics perspective (shipping the layers separately) and manpower perspective (forming the fitment by hand) to supply the fitment 10 in this way.

It is therefore an aim of the present disclosure to overcome the aforementioned foreseeable inefficiency with supplying a dual layer fitment.

In one example method of manufacture, the two layers 100, 200 may be suitably provided overlapping with each other—e.g. one on top of the other—with outer edges and fold lines aligned, as discussed variously above. That is, a flat but unfolded fitment 10, with the two layers 100, 200 overlapping and touching such that respective fold lines, and in particular the engagement feature 18 of the respective layers, are in alignment, may be provided as an input to a packaging device. The packaging device may be provided with a punching means that pushes the decorative first layer 100 towards the robust second layer 200 such that the layers 100, 200 become engaged via the engagement feature(s) 18 and the side walls 20 and receptors 22 become pre-folded. In other words, the packing device may fold the two layers along one or more of the fold lines that have been previously provided on the first layer 100 and second layer 200. In this way the two layers 100, 200 may be engaged with each other whilst simultaneously pre-folding the fitment 10 along the pre-determined lines/creases/cuts. As the two layers 100, 200 are now engaged the fitment 10 may be suitably returned to a flat configuration whilst retaining ease of manipulation due to the pre-folding. To the inventor's knowledge there are presently no packaging devices capable of engaging and pre-folding a dual layer fitment in this way.

It will also be appreciated that such a method of manufacture may be applied to a fitment comprising a single layer of cardboard with at least one predetermined fold line. That is the fitment may be provided to a mechanical folding device in a substantially flat configuration, subsequently mechanically manipulated so as to fold the fitment along the at least one pre-determined fold line, and then returned to the substantially same flat configuration.

Flat goods of course take up less space in a container, and therefore the (engaged) fitment 10 being in a flat configuration may be more quickly and conveniently loaded into containers for supply to packagers (either internal or external). As the fitment 10 has been pre-engaged and pre-folded it is also more convenient for the packager to form the fitment as the need for aligning and pre-folding the fitment 10 by the packager has been removed—i.e. carefully breaking/manipulating the fitment 10 along the creases prior to three-dimensional forming. The packager is also unlikely to require specialist training as it will be more readily apparent from the pre-folds how the fitment arranges into its final 3D form. As mentioned above, the packager in this particular example is envisaged as someone being remote from the manufacture such that some form of shipping/delivery to the packager is required. However, it will be appreciated that the benefits of pre-engaging and pre-folding the fitment 10 would also be realized by immediate “on site” use of the fitment by a packager.

As can be seen in FIG. 3A, the first layer 100 is further provided with a window 111 which is designed to receive a product 12 (see also the product receptors 22 in FIGS. 1 & 2). The window 111 is shown as square shaped, with foldable creases 112 indented into the body of the first layer 100 along the outer edge of its square outline. The inside lines 113 of the window 111 are cuts, such that the window 111 is formed from a series of flaps 114 which can be pushed down when receiving the product 12. In general, the window 111 may be formed from at least one foldable flap.

As can be seen from FIG. 3B, the second layer 200 is also provided with a window 211, also formed in a generally square shape with foldable outer edge 212 and cuts 113. The under window 211 is positioned to match the position of the top window 111 when the first layer 100 and second layer 200 are engaged. That is, the first layer window 111 and second layer window 211 are openings in their respective layers that are substantially aligned with one another.

The second window 211 supports the first window 111 during the folding process by providing a supporting base. The first layer crease lines 112 substantially match the second layer crease lines 212 such that the two layers fold along the same line. In this way when the first layer window 111 is folded towards the second layer window 211, the first layer flaps 114 push against the second layer flaps 214. Thus, the first layer 100, and in particular the window 111, is provided with additional strength during manipulation. This additional strength beneficially allows for the fitment 10 to be mechanically manipulated even after engaging the two layers with each other.

In some embodiments the creases on the second layer 200 are more indented, or more scored, compared to the creases on the first layer 100. In this way the under layer 200 folds easier. Thus, it is possible to set a mechanical manipulation to have sufficient force to fold the first layer 100 neatly but not sufficient to fold the second layer 200 except along the pre-set crease lines 212. In this way controllable mechanical pre-folding of the first layer 100 is provided. Of course, the second layer 200 will also be pre-folded to some degree.

Example materials for the decorative first layer 100 include cartonboard or microflute. These materials have suitable (thin) thickness and quality to be easily and quickly printed on using current manufacturing techniques. An example second layer 200 material is solid board or corrugated card board. It is not possible to print onto such cardboard to the same print standard as cartonboard or microflute and hence are not suitable for the first layer 100.

In one arrangement microflute corrugated material is used for both the first layer 100 and second layer 200, although only the first layer 100 need have a suitable surface for printing. The direction of corrugation is then advantageously set to be opposite such that the corrugation of the two layers lock into each other. Advantageously additional strength is provided to the fitment to prevent damage to the products whilst still providing a good quality printing surface and removing the use of the glue in the packaging.

1. A fitment comprising:
a first layer and a second layer suitable for securing to each other via a mechanical engagement feature, wherein the mechanical engagement feature aligns the first layer and the second layer relative to each other when the first layer and the second layer are engaged and the fitment is folded such that the first layer and the second layer are in contact and at least one of the first layer or the second layer at least partially encloses the other of the first layer or the second layer.

2. The fitment of claim 1, wherein the first layer comprises a tab and the second layer comprises an opening, the tab and the opening together forming the mechanical engagement feature and being engaged when the tab is inserted into the opening.

3. The fitment of claim 1, wherein the tab is larger than the opening in at least one dimension.

4. The fitment of claim 3, wherein the tab is provided with at least one flange to extend the tab in the at least one dimension.

5. The fitment of claim 1, wherein the mechanical engagement feature is positioned on a side wall of the fitment.

6. The fitment of claim 1, comprising at least two mechanical engagement features.

7. The fitment of claim 6, wherein the mechanical engagement features are positioned symmetrically opposite each other on opposite sides of the fitment with respect to a center line of the fitment.

8. The fitment of claim 1, wherein the first layer and the second layer are substantially the same shape and are folded along substantially the same lines when in use, and the first layer and the second layer are considered to be aligned when fold lines of the first layer are coincident with fold lines of the second layer.

9. The fitment of claim 1, wherein the mechanical engagement feature comprises a neck portion along which the first layer is moved relative to the second layer to adjust a position and an alignment of the first layer and the second layer after engagement.

10. The fitment of claim 9, wherein the neck portion provides for a side wall angle of 45 degrees relative to a surface of the fitment when the fitment is folded in use.

11. The fitment of claim 1, wherein the first layer and the second layer are different thicknesses.

12. A carton in combination with the fitment according to claim 1.

13. The carton of claim 12, wherein the mechanical engagement feature of the fitment is obscured from view of a user of the carton during normal use.

14. A fitment comprising:
a first layer and a second layer, the first layer comprising a first foldable window and the second layer comprising a second foldable window, wherein the first foldable window is substantially aligned with the second foldable window, and wherein the second foldable window provides a supporting force to the first foldable window during a folding action of folding the first foldable window towards the second foldable window.

15. The fitment of claim 14, wherein the first foldable window and the second foldable window are formed from at least one foldable flap on a respective one of the first layer and the second layer.

16. The fitment of claim 14, wherein the first foldable window comprises a crease line which is substantially coincident with a crease line of the second foldable window, and wherein the folding action causes the first layer and the second layer to fold along the same crease line.

17. The fitment of claim 16, wherein the crease line of the first foldable window is provided as an indent and the crease line on the second foldable window is provided as a stronger indent or score as compared to the indent of the first foldable window.

18. The fitment of claim 14, wherein a force required to fold the first foldable window is greater than a force required to fold the second foldable window and less than a force required to fold an un-creased part of the second layer.

19. The fitment of claim 14, wherein the first layer comprises one or more of cartonboard or microflute, and the second layer comprises one or more of solid board or corrugated cardboard.

20. The fitment of claim 14, wherein both the first layer and the second layer comprise microflute corrugated cardboard.

21. A method of manufacturing the fitment according to claim 1, comprising:
overlapping the first layer and the second layer such that the mechanical engagement feature is in a position ready for engagement; and
mechanically manipulating the first layer and the second layer such that the mechanical engagement feature engages while simultaneously folding the first layer and the second layer along at least one predetermined fold line.

22. The method of claim 21, further comprising manipulating the folded and engaged first layer and second layer into a substantially two-dimensional configuration such that the fitment exists in a pre-folded state.

23. The method of claim 22, wherein the pre-folded fitment is provided to a user ready for manipulation into a three-dimensional configuration.

24. A method of pre-folding a fitment comprising a layer with at least one predetermined fold line, the method comprising:
providing the fitment to a mechanical folding device in a substantially flat configuration;
mechanically manipulating the fitment so that the fitment is folded along the at least one predetermined fold line; and
returning the fitment to the substantially flat configuration.
